(19) United States
(12) Patent Application Publication
(10) Pub. No.: US 2026/0086485 A1
(43) Pub. Date: Mar. 26, 2026

(54) SHEET ACCOMMODATION DEVICE AND IMAGE FORMING APPARATUS

(71) Applicant: FUJIFILM Business Innovation Corp., Tokyo (JP)

(72) Inventors: Yuya OKAWA, Kanagawa (JP); Shinji YAGINUMA, Kanagawa (JP); Shuhei KOBORI, Kanagawa (JP)

(73) Assignee: FUJIFILM Business Innovation Corp., Tokyo (JP)

(21) Appl. No.: 19/070,147

(22) Filed: Mar. 4, 2025

(30) Foreign Application Priority Data
Sep. 25, 2024 (JP) 2024-165869

(51) Int. Cl. G03G 15/00

(52) U.S. Cl. CPC G03G 15/6502

(57) ABSTRACT

A sheet accommodation device includes: a sheet accommodation body that accommodates a sheet and is mounted in an apparatus main body to be pullable out from and pullable into the apparatus main body; an engaging unit that is provided on any one of the apparatus main body or the sheet accommodation body; and a pulling-in unit that is provided on the other of the apparatus main body or the sheet accommodation body and that has a guide groove guiding a pulling-in operation of the sheet accommodation body by being engaged with the engaging unit, the guide groove being provided with a resistance force applying portion that applies a resistance force to the pulling-in operation of the sheet accommodation body.

### CROSS-REFERENCE TO RELATED APPLICATIONS

This application is based on and claims priority under 35 USC 119 from Japanese Patent Application No. 2024-165869 filed Sep. 25, 2024.

### BACKGROUND

### (i) Technical Field

The present invention relates to a sheet accommodation device and an image forming apparatus.

### (ii) Related Art

In the related art, technologies related to a sheet accommodation device have already been proposed, for example, as disclosed in JP2006-151687A and JP2008-184245A.

In JP2006-151687A, a groove of guiding means is constituted by a straight portion parallel to a mounting direction of sheet storing means and a curved portion that is provided downstream of the straight portion in the mounting direction and that is curved in a direction of a swing fulcrum of pulling-in means.

In JP2008-184245A, a formation range of an introduction opening portion in a direction orthogonal to a sheet storage portion mounting direction is set to be the same as or smaller than a formation range of a guide groove in the direction orthogonal to the sheet storage portion mounting direction.

### SUMMARY

Aspects of non-limiting embodiments of the present disclosure relate to a sheet accommodation device and an image forming apparatus that enable adjustment of a pulling-in force of a sheet accommodation body compared to a case where a guide groove of a pulling-in unit is not provided with a resistance force applying portion.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a sheet accommodation device including: a sheet accommodation body that accommodates a sheet and is mounted in an apparatus main body to be pullable out from and pullable into the apparatus main body; an engaging unit that is provided on any one of the apparatus main body or the sheet accommodation body; and a pulling-in unit that is provided on the other of the apparatus main body or the sheet accommodation body and that has a guide groove guiding a pulling-in operation of the sheet accommodation body by being engaged with the engaging unit, the guide groove being provided with a resistance force applying portion that applies a resistance force to the pulling-in operation of the sheet accommodation body.

The resistance force refers to, in a case where an object comes into contact with another object and exerts a force, a force exerted back by the other object as a reaction to the force. Here, the resistance force is, in a case where the engaging unit comes into contact with the resistance force applying portion of the guide groove of the pulling-in unit and applies a force, a force exerted back by the resistance force applying portion of the guide groove on the engaging unit as a reaction to the force.

### BRIEF DESCRIPTION OF THE DRAWINGS

Exemplary embodiment(s) of the present invention will be described in detail based on the following figures, wherein:

FIG. 1 is an overall configuration diagram showing an image forming apparatus to which a sheet accommodation device according to a first exemplary embodiment of the invention is applied;

FIG. 2 is a configuration diagram showing an image forming section of the image forming apparatus according to the first exemplary embodiment of the invention;

FIG. 3 is a perspective configuration diagram showing a paper feed tray of the sheet accommodation device according to the first exemplary embodiment of the invention;

FIG. 4 is a cross-sectional configuration diagram showing major portions of the sheet accommodation device according to the first exemplary embodiment of the invention;

FIG. 5 is a perspective configuration diagram showing the sheet accommodation device;

FIG. 6 is a perspective configuration diagram showing an apparatus main body of the image forming apparatus to which the sheet accommodation device according to the first exemplary embodiment of the invention is applied;

FIG. 7 is a plan configuration diagram showing a state in which a locking pin is attached;

FIG. 8 is a plan configuration diagram showing a pulling-in device;

FIG. 9 is a plan configuration diagram showing the pulling-in device;

FIG. 10 is a perspective configuration diagram showing the pulling-in device;

FIG. 11 is a perspective configuration diagram showing a bracket;

FIGS. 12A, 12B, and 12C are configuration diagrams showing a mechanical one-way clutch;

FIG. 13 is a configuration diagram showing major portions of a pulling-in device in the related art;

FIG. 14 is an enlarged configuration diagram showing major portions of the pulling-in device in the sheet accommodation device according to the first exemplary embodiment of the invention;

FIG. 15 is a configuration diagram showing the major portions of the pulling-in device in the sheet accommodation device according to the first exemplary embodiment of the invention;

FIG. 16 is a configuration diagram showing an operation of the pulling-in device in the sheet accommodation device according to the first exemplary embodiment of the invention;

FIG. 17 is a configuration diagram showing the operation of the pulling-in device in the sheet accommodation device according to the first exemplary embodiment of the invention;

FIG. 18 is a configuration diagram showing a comparative example; and

FIG. 19 is a configuration diagram showing major portions of a pulling-in device in a sheet accommodation device according to a second exemplary embodiment of the invention.

### DETAILED DESCRIPTION

Hereinafter, exemplary embodiments of the present invention will be described with reference to the drawings.

### First Exemplary Embodiment

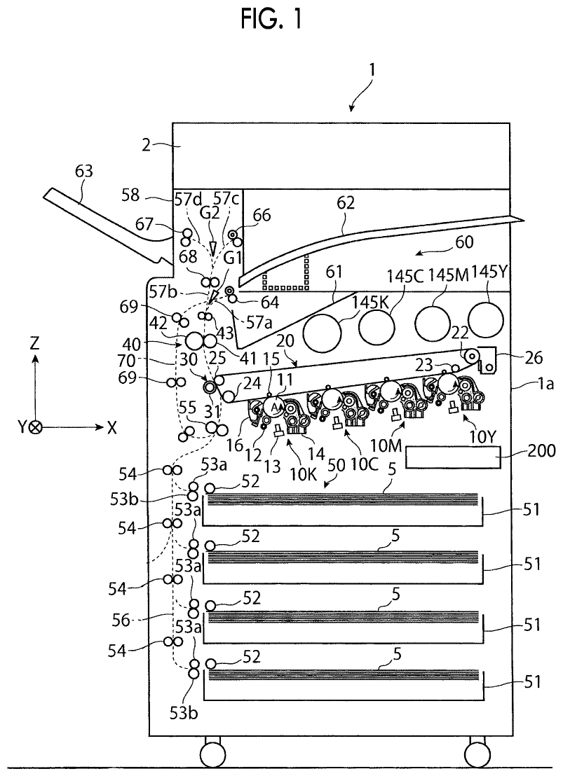

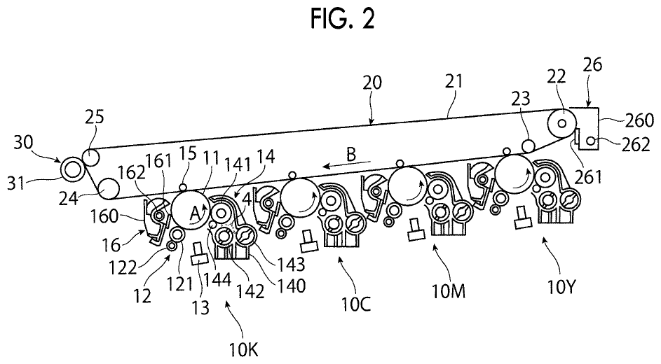

FIGS. 1 and 2 show an image forming apparatus to which a sheet accommodation device according to a first exemplary embodiment is applied. FIG. 1 shows an overall outline of the image forming apparatus, and FIG. 2 shows an enlarged view of major portions (an image forming device and the like) of the image forming apparatus. In FIG. 1, reference symbol X indicates a horizontal direction (a width direction) of the image forming apparatus, reference symbol Y indicates a depth direction of the image forming apparatus, and reference symbol Z indicates a vertical direction of the image forming apparatus.

### Overall Configuration of Image Forming Apparatus

An image forming apparatus 1 according to the first exemplary embodiment is configured as, for example, a color printer. The image forming apparatus 1 includes, at an upper end of an apparatus main body 1a, an image reading device 2 that reads an image of a document (not shown). The image forming apparatus 1 functions as a color printer or the like that records image information sent from a host computer (not shown) or the like, in addition to functioning to copy the image of the document read by the image reading device 2.

The image forming apparatus 1 includes, inside the apparatus main body 1a, a plurality of image forming devices 10, an intermediate transfer device 20, a sheet accommodation device 50 according to the first exemplary embodiment, a fixing device 40, and the like. The plurality of image forming devices 10 form toner images which are developed by toner constituting a developer. The intermediate transfer device 20 holds the toner image formed by each image forming device 10, and transports the toner image to a secondary transfer position where the toner image is finally secondarily transferred to recording paper 5, which is an example of a sheet. The sheet accommodation device 50 accommodates and feeds the recording paper 5 to be supplied to the secondary transfer position of the intermediate transfer device 20. The fixing device 40 fixes the toner image on the recording paper 5 to which the toner image has been secondarily transferred by the intermediate transfer device 20. The plurality of image forming devices 10 and the intermediate transfer device 20 constitute an image forming unit that forms an image on the recording paper 5. The apparatus main body 1a of the image forming apparatus 1 is formed of a support structural member, an exterior cover, or the like.

The image forming device 10 includes four image forming devices 10Y, 10M, 10C, and 10K that exclusively form toner images of four colors including yellow (Y), magenta (M), cyan (C), and black (K), respectively. The four image forming devices 10 (Y, M, C, K) are disposed in a row in an inclined state in an internal space of the apparatus main body 1a.

Each of the image forming devices 10 (Y, M, C, and K) of yellow (Y), magenta (M), cyan (C), and black (K) includes a rotating photoreceptor drum 11 as an example of an image holding body that holds an electrostatic latent image, as shown in FIGS. 1 and 2. A charging device 12, an exposing device 13, a developing device 14, a primary transfer device 15, a drum cleaning device 16, and the like are disposed around the photoreceptor drum 11. The charging device 12 charges a peripheral surface (an image holding surface) of the photoreceptor drum 11, on which an image can be formed, to a required potential. The exposing device 13 irradiates the charged peripheral surface of the photoreceptor drum 11 with light based on information (a signal) on an image to form an electrostatic latent image for each color with a potential difference. The developing device 14 develops the electrostatic latent image with toner of the developer of the corresponding color (Y, M, C, K) to obtain a toner image. The primary transfer device 15 transfers each toner image to the intermediate transfer device 20. The drum cleaning device 16 removes and cleans adhering substances, such as toner, remaining on and adhering to the image holding surface of the photoreceptor drum 11 after the primary transfer.

The photoreceptor drum 11 is obtained by forming, on a peripheral surface of a cylindrical or columnar base material that is grounded, an image holding surface including a photoconductive layer (a photosensitive layer) consisting of a photosensitive material. The photoreceptor drum 11 is supported to rotate in a direction indicated by arrow A as power is transmitted from a drive device (not shown).

As shown in FIG. 2, the charging device 12 is configured by a contact-type charging roll 121 that is disposed in a state of being in contact with the photoreceptor drum 11. A cleaning roll 122 that cleans a surface of the charging roll 121 is disposed on a back surface of the charging roll 121. A charging voltage is supplied to the charging roll 121 of the charging device 12. As the charging voltage, in a case where the developing device 14 performs reverse development, a voltage or a current having the same polarity as a charging polarity of the toner supplied from the developing device 14 is supplied.

The exposing device 13 irradiates the peripheral surface of the charged photoreceptor drum 11 with light that is configured according to the image information of the document read by the image reading device 2 or the information on the image input to the image forming apparatus 1 to form an electrostatic latent image. In a case where the latent image is formed, the image information of the document read by the image reading device 2 or the information on the image input to the image forming apparatus 1 by any means is transmitted to the exposing device 13.

The exposing device 13 consists of a light emitting diode (LED) printhead that irradiates the photoreceptor drum 11 with light according to the image information by LEDs serving as a plurality of light emitting elements arranged along an axial direction of the photoreceptor drum 11 to form an electrostatic latent image.

Each of the developing devices 14 is configured by disposing a developing roll 141, an agitating and supplying member 142, an agitating and transporting member 143, a layer thickness regulating member 144, and the like inside a housing 140. The housing 140 is formed with an opening portion at a position facing the photoreceptor drum 11 and an accommodation chamber for the developer. The developing roll 141 holds a developer 4 and transports the developer 4 to a development region facing the photoreceptor drum 11. The agitating and supplying member 142 consists of a screw auger or the like that supplies the developer 4 such that the developer 4 passes through the developing roll 141 while agitating the developer 4. The agitating and transporting member 143 consists of a screw auger or the like that transports the developer 4 to the agitating and supplying member 142 while agitating the developer 4. The layer thickness regulating member 144 regulates the amount (layer thickness) of the developer 4 held on the developing roll 141. In the developing device 14, a developing voltage is supplied from a power supply device (not shown) to a portion between the developing roll 141 and the photoreceptor drum 11. For example, a two-component developer containing a non-magnetic toner and a magnetic carrier is used as the developers 4 of four colors.

The primary transfer device 15 is a contact-type transfer device including a primary transfer roll that rotates around the photoreceptor drum 11 in contact with the photoreceptor drum 11 via an intermediate transfer belt 21 and that is supplied with a primary transfer voltage. As the primary transfer voltage, a direct-current voltage having a polarity opposite to the charging polarity of the toner is supplied from the power supply device (not shown).

As shown in FIG. 2, the drum cleaning device 16 is constituted by a main body 160, a cleaning plate 161, a sending member 162, and the like. The main body 160 is formed in a container shape of which a portion is open. The cleaning plate 161 is disposed to be in contact with the peripheral surface of the photoreceptor drum 11 after the primary transfer at a required pressure to remove and clean the adhering substances such as the residual toner. The sending member 162 consists of a screw auger or the like that recovers the adhering substances such as the toner removed by the cleaning plate 161 and transports the adhering substances to be sent to a recovery system (not shown).

As shown in FIG. 1, the intermediate transfer device 20 is disposed to be present at a position above the image forming devices 10 (Y, M, C, K) along the vertical direction Z. The intermediate transfer device 20 is primarily constituted by the intermediate transfer belt 21, a plurality of belt support rolls 22 to 25, a secondary transfer device 30, and a belt cleaning device 26. As shown in FIG. 2, the intermediate transfer belt 21 rotates in a direction indicated by arrow B while passing through a primary transfer position between the photoreceptor drum 11 and the primary transfer device 15. The plurality of belt support rolls 22 to 25 rotatably support the intermediate transfer belt 21 by holding the intermediate transfer belt 21 from an inner surface thereof in a desired state. The secondary transfer device 30 is disposed on an outer peripheral surface (image holding surface) side of the intermediate transfer belt 21 supported by the belt support rolls 25 and secondarily transfers a toner image on the intermediate transfer belt 21 to the recording paper 5. The belt cleaning device 26 removes and cleans the adhering substances, such as toner and paper dust, remaining on and adhering to the outer peripheral surface of the intermediate transfer belt 21 after passing through the secondary transfer device 30.

In addition, the belt support roll 22 is configured as a drive roll that is rotatably driven by a drive device (not shown). The belt support roll 23 is configured as an alignment roll that holds a running position of the intermediate transfer belt 21. The belt support roll 24 is configured as a facing roll that faces a sensor (not shown). The belt support roll 25 is configured as a backup roll for the secondary transfer.

The secondary transfer device 30 is a contact-type transfer device including a secondary transfer roll 31. The secondary transfer roll 31 rotates in contact with a peripheral surface of the intermediate transfer belt 21 at the secondary transfer position, which is an outer peripheral surface portion of the intermediate transfer belt 21 supported by the belt support rolls 25 in the intermediate transfer device 20, and is supplied with a secondary transfer voltage. In addition, a direct-current voltage having a polarity opposite to or the same as the charging polarity of the toner is supplied as the secondary transfer voltage to the secondary transfer roll 31 or the belt support roll 25 of the intermediate transfer device 20.

As shown in FIG. 2, the belt cleaning device 26 is constituted by a main body 260, a cleaning plate 261, a sending member 262, and the like. The main body 260 is formed in a container shape of which a portion is open. The cleaning plate 261 is disposed to be in contact with the peripheral surface of the intermediate transfer belt 21 after the secondary transfer at a required pressure to remove and clean the adhering substances such as the residual toner. The sending member 262 is formed of a screw auger or the like that recovers the adhering substances such as the toner removed by the cleaning plate 261 and transports the adhering substances to be sent to a recovery system (not shown).

The fixing device 40 is configured by disposing a heating rotating body 41, a pressurizing rotating body 42, and the like. The heating rotating body 41 is formed in a roll form or a belt form which is heated by heating means such that a surface temperature of the heating rotating body 41 is maintained at a required temperature. The pressurizing rotating body 42 is formed in a roll form or a belt form that rotates in contact with the heating rotating body 41 at a predetermined pressure in a state substantially along an axial direction of the heating rotating body 41. An exit roll 43 that transports the recording paper 5 on which a fixing process is performed is provided at an exit portion of the fixing device 40. In the fixing device 40, a contact portion where the heating rotating body 41 and the pressurizing rotating body 42 come into contact with each other becomes a fixing processing unit that performs a required fixing process.

The sheet accommodation device 50 is disposed to be present at a position below the image forming devices 10 (Y, M, C, K) of yellow (Y), magenta (M), cyan (C), and black (K) along the vertical direction Z. The sheet accommodation device 50 is primarily constituted by a plurality (or single) of paper feed trays 51 as an example of a sheet accommodation body, a nudger roll 52, a feed roll 53a, and a retard roll 53b. The paper feed tray 51 accommodates the recording paper 5 having a desired size, type, and the like in a state of being loaded. The nudger roll 52 sends out the recording paper 5 from the paper feed tray 51. The feed roll 53a and the retard roll 53b separate and feed the recording paper 5 sent out by the nudger roll 52 one by one. The paper feed tray 51 is attached to, for example, a front surface (a side surface facing a user in a case of performing an operation) side of the apparatus main body 1a, and in the illustrated example, is attached to a front side of the paper surface to be pulled out. The sheet accommodation device 50 will be described in detail later.

A paper feed transport path 56 is provided between the sheet accommodation device 50 and the secondary transfer device 30. The paper feed transport path 56 is constituted by a plurality (or single) of paper transport roll pairs 54 and 55 that transport the recording paper 5 sent out from the sheet accommodation device 50 to the secondary transfer position, a transport guide (not shown), and the like. The paper transport roll pair 55 is configured as, for example, registration rolls that adjust a transport timing of the recording paper 5. In addition, a paper discharge transport unit 58 for discharging the recording paper 5 after fixation sent out from the exit roll 43 of the fixing device 40 to a sheet discharge device 60 is provided above the fixing device 40 along the vertical direction Z. The sheet discharge device 60 is disposed in an upper portion of the apparatus main body 1a. The paper discharge transport unit 58 includes first to fourth paper discharge transport paths 57a to 57d.

The sheet discharge device 60 includes first and second discharge trays 61 and 62 and a third discharge tray 63. The first and second discharge trays 61 and 62 are of a so-called internal discharge type provided in the upper portion of the apparatus main body 1a. The third discharge tray 63 is provided to face outward on a side surface (in the drawing, a left side surface) of the paper discharge transport unit 58. The first paper discharge transport path 57a, the third paper discharge transport path 57c, and the fourth paper discharge transport path 57d are provided inside the paper discharge transport unit 58. The first paper discharge transport path 57a branches off from the second paper discharge transport path 57b and includes a first paper discharge roll pair 64 for discharging the recording paper 5 to the first discharge tray 61. The third paper discharge transport path 57c branches off from the second paper discharge transport path 57b and includes a second paper discharge roll pair 66 for discharging the recording paper 5 to the second discharge tray 62. The fourth paper discharge transport path 57d branches off from the third paper discharge transport path 57c and includes a third paper discharge roll pair 67 for discharging the recording paper 5 to the third discharge tray 63.

In FIG. 1, reference symbol 68 denotes a paper transport roll pair provided in the middle of the second paper discharge transport path 57b. Reference symbol G1 denotes a first switching gate that branches the first paper discharge transport path 57a and the second paper discharge transport path 57b. Reference numeral G2 denotes a second switching gate that branches the third paper discharge transport path 57c and the fourth paper discharge transport path 57d.

In addition, as shown in FIG. 1, a two-sided transport path 70 is provided inside the apparatus main body 1a. The two-sided transport path 70 switches a rotation direction of the first paper discharge roll pair 64 from a forward direction to a reverse direction while the recording paper 5 with an image formed on one side thereof is held by the first paper discharge roll pair 64. The two-sided transport path 70 includes a paper transport roll pair 69 that transports the recording paper 5 of which the front and back are reversed to the paper transport roll pair 55 again.

In FIG. 1, reference symbols 145 (Y, M, C, K) denote toner cartridges accommodating developers containing at least toner to be supplied to the corresponding developing devices 14, respectively. A plurality of toner cartridges 145 (Y, M, C, K) are arranged along a direction perpendicular to the paper surface.

In addition, reference symbol 200 in FIG. 1 denotes a control device that comprehensively controls an operation of the image forming apparatus 1. The control device 200 includes a central processing unit (CPU), a read only memory (ROM), a random access memory (RAM), a bus that connects the CPU, the ROM, and the like to each other, a communication interface, and the like, all of which are not shown.

### Operation of Image Forming Apparatus

Hereinafter, a basic image forming operation by the image forming apparatus 1 will be described.

Herein, an operation of forming a full-color image configured by combining toner images of four colors (Y, M, C, K) using the four image forming devices 10 (Y, M, C, K) will be described.

In a case where the control device 200 receives command information requesting for an image forming operation (printing), the image forming apparatus 1 starts the four image forming devices 10 (Y, M, C, K), the intermediate transfer device 20, the secondary transfer device 30, the fixing device 40, and the like.

Then, in each of the image forming devices 10 (Y, M, C, K), first, each photoreceptor drum 11 rotates in a direction indicated by arrow A, and each charging device 12 charges a surface of each photoreceptor drum 11 to a required polarity and potential. Next, the exposing device 13 irradiates the surface of the charged photoreceptor drum 11 with light emitted based on an image signal which is obtained by converting image information input to the image forming apparatus 1 into each color component (Y, M, C, K). Then, an electrostatic latent image of each color component, which is formed by a required potential difference, is formed on the surface of the charged photoreceptor drum 11.

Next, each developing device 14 develops the electrostatic latent image of each color component formed on the photoreceptor drum 11 by supplying toner of the corresponding color (Y, M, C, K) charged to the required polarity from the developing roll 141 and causing the toner to electrostatically adhere to the electrostatic latent image. Through such development, the electrostatic latent images of the respective color components formed on the photoreceptor drums 11 are visualized as the toner images of four colors (Y, M, C, K) developed with the toners of the corresponding colors.

Next, the toner images of the respective colors formed on the photoreceptor drums 11 of the image forming devices 10 (Y, M, C, K) are transported to the primary transfer positions. Then, the primary transfer devices 15 primarily transfer the toner images of the respective colors onto the intermediate transfer belt 21 of the intermediate transfer device 20 rotating in a direction along the arrow B in a state in which the toner images are superimposed in order.

In addition, in each image forming device 10 (Y, M, C, K) in which the primary transfer is ended, the drum cleaning device 16 cleans the surface of the photoreceptor drum 11 by scraping off and removing the adhering substances. Accordingly, each image forming device 10 (Y, M, C, K) is brought into a state where the next image forming operation can be performed.

Next, in the intermediate transfer device 20, the toner images that are primarily transferred by the rotation of the intermediate transfer belt 21 are held and transported to the secondary transfer position. On the other hand, the sheet accommodation device 50 sends out the required recording paper 5 to the paper feed transport path 56 in accordance with the image forming operation. In the paper feed transport path 56, the paper transport roll pair 55 as the registration rolls sends out and supplies the recording paper 5 to the secondary transfer position in accordance with a transfer timing.

At the secondary transfer position, the secondary transfer roll 31 of the secondary transfer device 30 collectively and secondarily transfers the toner images on the intermediate transfer belt 21 to the recording paper 5. In addition, in the intermediate transfer device 20 that has ended the secondary transfer, the belt cleaning device 26 performs cleaning by removing the adhering substances such as the toner remaining on the surface of the intermediate transfer belt 21 after the secondary transfer.

Next, the recording paper 5 to which the toner images are secondarily transferred is transported to the fixing device 40 after being peeled off the intermediate transfer belt 21 and the secondary transfer roll 31. In the fixing device 40, the recording paper 5 after the secondary transfer is introduced into and passes through the contact portion between the heating rotating body 41 and the pressurizing rotating body 42 which rotate. In this manner, the unfixed toner images are fixed onto the recording paper 5 by performing the required fixing process. Finally, in a case of an image forming operation of forming an image on one side only, the recording paper 5 after fixing has ended is discharged to any one of the first to third discharge trays 61 to 63 installed in the upper portion of the apparatus main body 1a via the first to fourth paper discharge transport paths 57a to 57d.

In addition, in a case of forming images on both sides of the recording paper 5, the recording paper 5 with the image formed on one side thereof is transported by the first paper discharge roll pair 64 in a discharge direction of the first discharge tray 61. Then, while the first paper discharge roll pair 64 holds a rear end of the recording paper 5, the rotation direction of the first paper discharge roll pair 64 is switched to the reverse direction. The recording paper 5 transported in the reverse direction by the first paper discharge roll pair 64 is transported to the two-sided transport path 70 including the paper transport roll pair 69 and the like and is transported to the paper transport roll pair 55 again in a state where the front and back are reversed. The paper transport roll pair 55 send out and supplies the recording paper 5 to the secondary transfer position in accordance with the transfer timing. The image is formed on the back surface of the recording paper 5 and fixed. The recording paper 5 with the image fixed onto the back surface is discharged to any one of the first to third discharge trays 61 to 63 installed in the upper portion of the apparatus main body 1a via any one of the first to fourth paper discharge transport paths 57a to 57d.

With the operation above, the recording paper 5 having one side or both sides on which a full-color image configured by combining the toner images of four colors is formed is output.

### Configuration of Sheet Accommodation Device

As shown in FIG. 1, the image forming apparatus 1 includes the sheet accommodation device 50. The sheet accommodation device 50 is disposed inside the apparatus main body 1a to be present at a position below the image forming devices 10 (Y, M, C, K) of yellow (Y), magenta (M), cyan (C), and black (K) along the vertical direction Z. The apparatus main body 1a of the image forming apparatus 1 also serves as a device main body of the sheet accommodation device 50. The sheet accommodation device 50 is primarily constituted by the plurality of (four in the illustrated example) paper feed trays 51, the nudger roll 52, the feed roll 53a, and the retard roll 53b. The paper feed tray 51 accommodates the recording paper 5 having a desired size, type, and the like in a state of being loaded. The nudger roll 52, the feed roll 53a, and the retard roll 53b send out the recording paper 5 from each of the paper feed trays 51 one by one.

As described above, the paper feed tray 51 is attached to, for example, the front surface (the side surface facing the user in a case of performing an operation) side of the apparatus main body 1a, and in the illustrated example, is attached to the front side of the paper surface to be able to be pulled out.

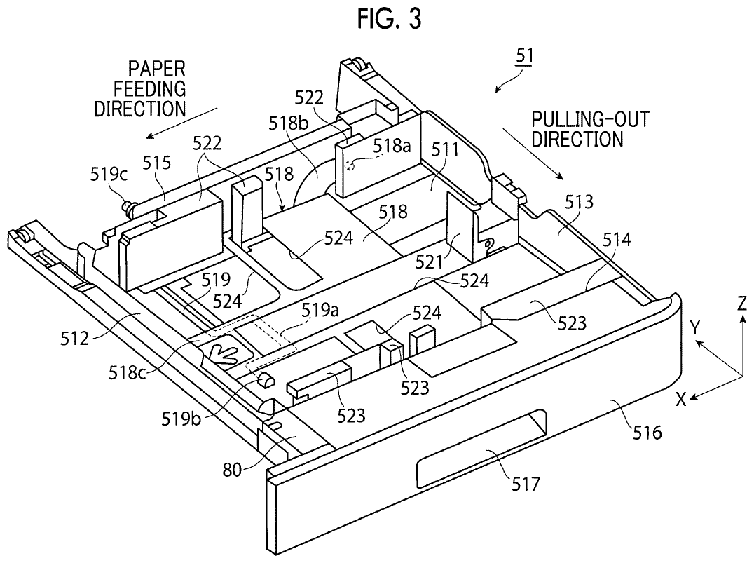

As shown in FIG. 3, the paper feed tray 51 is configured as a substantially rectangular parallelepiped box in which an upper end surface having a height corresponding to the number of sheets of the recording paper 5 accommodated therein is fully opened. The paper feed tray 51 includes a bottom wall portion 511, left and right side wall portions 512 and 513, and front and rear wall portions 514 and 515. The bottom wall portion 511 is formed in a substantially rectangular shape in a plan view. The left and right side wall portions 512 and 513 are disposed on the left and right sides of the bottom wall portion 511 along the horizontal direction X. In addition, the front and rear wall portions 514 and 515 are disposed at the front and rear of the bottom wall portion 511 along the depth direction Y. A front surface of the paper feed tray 51 is formed as an operation panel 516. The operation panel 516 constitutes an external shape of the front surface of the apparatus main body 1a together with a front panel (not shown) of the apparatus main body 1a. The operation panel 516 of the paper feed tray 51 is provided with a grip portion 517 on which a user puts a hand in a case of pulling out the paper feed tray 51 from the apparatus main body 1a or pushing (pulling) the paper feed tray 51 into the apparatus main body 1a.

The apparatus main body 1a is provided with detecting means (not shown) for detecting the pulling out of the paper feed tray 51 in a case where the user puts the hand on the grip portion 517 of the operation panel 516 and pulls out the paper feed tray 51 from the apparatus main body 1a. The detecting means may also serve as size detecting means 520b for detecting the size of the recording paper 5, which will be described below.

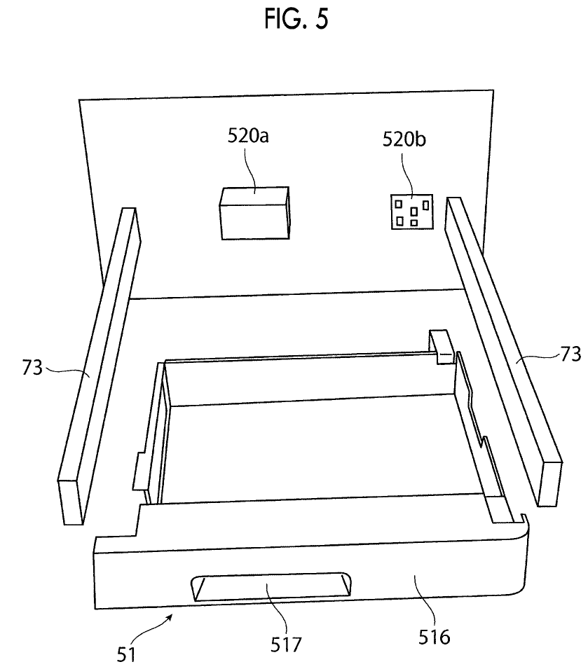

A bottom plate 518 on which a plurality of sheets of recording paper 5 are placed in a stacked state is disposed on the bottom wall portion 511 of the paper feed tray 51. The bottom plate 518 is attached to the front and rear wall portions 514 and 515 of the paper feed tray 51 so as to be rotationally move about a rotational movement fulcrum 518a. The rotational movement fulcrum 518a is provided on arm members 518b provided at both front and rear end portions of the bottom plate 518 along the depth direction Y. As a result, an end portion 518c of the bottom plate 518 on a downstream side along a paper feeding direction can be rotationally moved upward. A driving member 519 is rotatably disposed on a rear surface of the end portion 518c of the bottom plate 518 on the downstream side along the paper feeding direction. In the driving member 519, an intermediate portion 519a is formed in a crank shape as shown partially by a broken line in FIG. 3. A tip end of the drive member 519 is rotatably attached to the bottom wall portion 511 of the paper feed tray 51 via a shaft support portion 519b. A coupling member 519c that receives a driving force from the apparatus main body 1a is provided on the rear wall portion 515 of the paper feed tray 51. As shown in FIG. 5, in a case where the paper feed tray 51 is mounted at a paper feed position of the apparatus main body 1a, the driving force is transmitted to the driving member 519 from driving means 520a provided in the apparatus main body 1a via the coupling member 519c and the driving member 519 is driven to rotate in a required direction by a required angle.

In addition, in a case where the paper feed tray 51 is pulled out from the apparatus main body 1a, the bottom plate 518 is separated from the driving means 520a on an apparatus main body 1a side and is lowered to the bottom wall portion 511 by the weight of the bottom plate 518. FIG. 3 shows a state in which the bottom plate 518 is lowered to the bottom wall portion 511.

On the other hand, in a case where the detecting means (not shown) detects that the paper feed tray 51 is mounted at the paper feed position of the apparatus main body 1a, the bottom plate 518 is moved upward by the driving member 519 via the coupling member 519c by the driving means 520a on the apparatus main body 1a side. The bottom plate 518 stops at the paper feed position where the uppermost sheet of the recording paper 5 among the sheets of the recording paper 5 accommodated in the paper feed tray 51 abuts on the nudger roll 52.

As shown in FIG. 3, an end guide 521 and side guides 522 and 523 are disposed on the bottom wall portion 511 of the paper feed tray 51. The end guide 521 abuts on and positions an upstream end portion of the recording paper 5 accommodated in the paper feed tray 51 along the paper feeding direction. The side guides 522 and 523 abut on and position both end portions of the recording paper 5 along the width direction intersecting the paper feeding direction. The end guide 521 is attached to the bottom wall portion 511 of the paper feed tray 51 so as to be movable along the paper feeding direction of the recording paper 5 and to be able to hold a stop position. In addition, the side guides 522 and 523 are attached to the bottom wall portion 511 of the paper feed tray 51 so as to be move in tandem an equal distance along the width direction intersecting the paper feeding direction of the recording paper 5 with respect to a center of the width direction intersecting the paper feeding direction and to be able to hold a stop position. The paper feed tray 51 feeds the recording paper 5 with a center portion along the depth direction Y intersecting the paper feeding direction as a reference (so-called center registration). Size identifying means (not shown) for identifying the size of the recording paper 5 according to the positions of the end guide 521 and the side guides 522 and 523 is disposed on the rear wall portion 515 of the paper feed tray 51 toward a rear side. As shown in FIG. 5, the size identifying means is detected by the size detecting means 520b consisting of a plurality of switches and the like on the apparatus main body 1a side.

The bottom plate 518 is provided with a plurality of opening portions 524 having a flat rectangular shape that allow the end guide 521 and the side guides 522 and 523 to move.

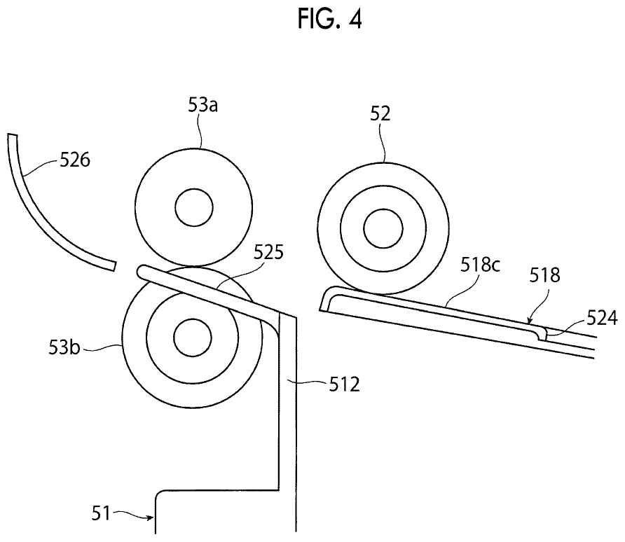

As shown in FIG. 4, in the sheet accommodation device 50, the nudger roll 52 is disposed at a position corresponding to an end portion of each paper feed tray 51 on the downstream side along the paper feeding direction so as to be rotatable at a required timing. The nudger roll 52 abuts on a surface of the uppermost sheet of the recording paper 5 among the sheets of the recording paper 5 loaded on the bottom plate 518 and feeds the uppermost sheet of the recording paper 5.

In addition, in the sheet accommodation device 50, the feed roll 53a and the retard roll 53b are disposed downstream of the nudger roll 52 in the paper feeding direction. The feed roll 53a and the retard roll 53b are drive to rotate at a required timing. The feed roll 53a is in pressure contact with the retard roll 53b and transports only one uppermost sheet of the recording paper 5 among the sheets of the recording paper 5 fed by the nudger roll 52 toward the downstream side along the paper feeding direction. On the other hand, the retard roll 53b is biased to rotate in a direction opposite to the feed roll 53a. The retard roll 53b transports the second and subsequent sheets of the recording paper 5, which are fed together with the uppermost sheet of the recording paper 5, in a direction opposite to the paper feeding direction. The retard roll 53b performs an action of handling the plurality of sheets of the recording paper 5 so that the plurality of sheets of the recording paper 5 are not fed at the same time.

The nudger roll 52, the feed roll 53a, and the retard roll 53b are disposed closer to the rear side of each of the paper feed trays 51 along the width direction intersecting the paper feeding direction of the recording paper 5.

As shown in FIG. 4, the left side wall portion 512 located at the end portion of the paper feed tray 51 on the downstream side along the paper feeding direction is provided with an introduction plate 525 that introduces a leading end of the recording paper 5 fed by the nudger roll 52 to a nip portion between the feed roll 53a and the retard roll 53b, on a front surface side along the width direction intersecting the paper feeding direction of the recording paper 5.

A guide member 526 as an example of a guide member is disposed in the apparatus main body 1a. The guide member 526 guides the recording paper 5 fed from the paper feed tray 51 by the nudger roll 52, the feed roll 53a, and the retard roll 53b upward along the vertical direction Z.

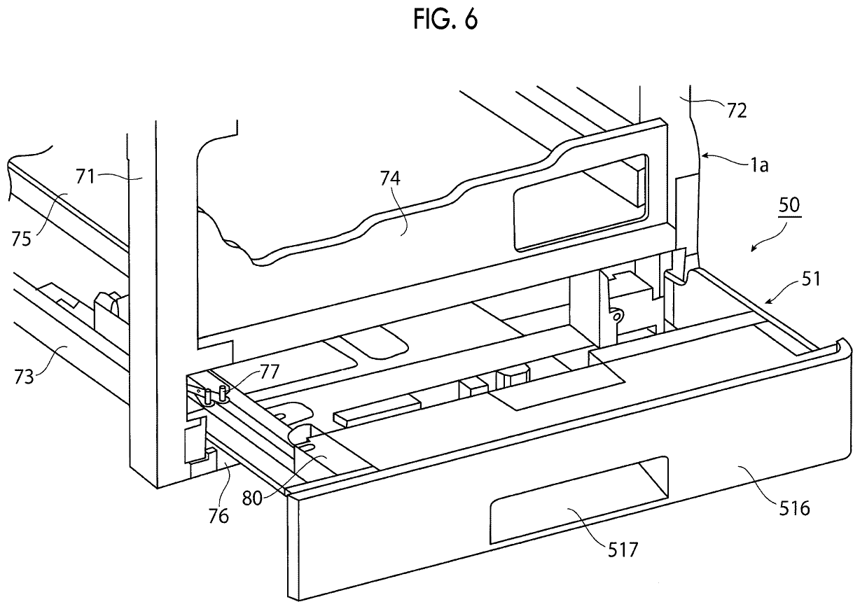

As shown in FIG. 6, the sheet accommodation device 50 is attached to a plurality of support frames 71, 72, and the like constituting the apparatus main body 1a of the image forming apparatus 1. The support frames 71 and 72 are provided with a horizontal frame 73, a front plate 74, a partition plate 75, a compartment plate 76, and the like by means of fastening with bolts (not shown). The horizontal frame 73 is disposed on each of the left and right sides of the apparatus main body 1a along the horizontal direction X. The left and right side wall portions 512 and 513 of the paper feed tray 51 are attached to the horizontal frames 73 on the left and right sides via guide rails and guide rollers (not shown) so as to be pulled out and pushed in. The image forming devices 10 (Y, M, C, K) of yellow (Y), magenta (M), cyan (C), and black (K) are attached to the front plate 74. The partition plate 75 partitions the image forming devices 10 (Y, M, C, K) from the sheet accommodation device 50. The compartment plate 76 divides a plurality of paper feed trays 51 of the sheet accommodation device 50. The nudger roll 52, the feed roll 53a, the retard roll 53b, and the like of the sheet accommodation device 50 are attached to the horizontal frame 73 on the left side.

The recording paper 5 fed from the sheet accommodation device 50 and guided upward along the vertical direction Z by the guide member 526 is transported to the secondary transfer position via the paper feed transport path 56 constituted by the plurality (or single) of paper transport roll pairs 54 and 55, the transport guide (not shown), and the like as shown in FIG. 1.

### Configuration of Pulling-In Device of Sheet Accommodation Device

The sheet accommodation device includes an engaging unit that is provided on any one of the apparatus main body or the sheet accommodation body and a pulling-in unit that is provided on the other of the apparatus main body or the sheet accommodation body and that has a guide groove guiding a pulling-in operation of pulling the sheet accommodation body into the apparatus main body by being engaged with the engaging unit.

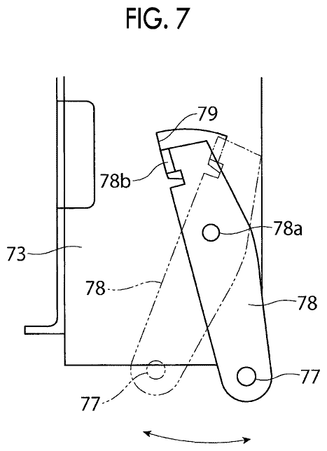

In the sheet accommodation device 50 according to the first exemplary embodiment, as shown in FIG. 6, an engaging pin 77 as an example of the engaging unit is provided in the apparatus main body 1a. The engaging pin 77 is formed of metal such as stainless steel in a columnar shape. The engaging pin 77 is attached to a tip end of a swing arm 78 in a state of being erected upward along the vertical direction Z. As shown in FIG. 7, the swing arm 78 is disposed at a front end portion of the horizontal frame 73 located at a left end portion of the apparatus main body 1a along the horizontal direction X so as to be swingable around a fulcrum 78a. In the swinging arm 78, a restriction plate 78b provided at an end portion on a side opposite to the engaging pin 77 relative to the fulcrum 78a is engaged with a fan-shaped groove portion 79 that is open to the horizontal frame 73, so that an angle at which the swinging arm 78 can swing is restricted.

As shown in FIG. 6, the sheet accommodation device 50 includes a pulling-in device 80 as an example of the pulling-in unit on a paper feed tray 51 side. The pulling-in device 80 performs the pulling-in operation of pulling the paper feed tray 51 into an inside of the apparatus main body 1a by being engaged with the engaging pin 77 on the apparatus main body 1a side. As shown in FIG. 3, the pulling-in device 80 is attached in a state of being fixed to a rear surface side of the operation panel 516 at front end portion of the paper feed tray 51 along the depth direction Y, that is, at the end portion on the downstream side along the paper feeding direction. The engaging pin 77 may be disposed in the paper feed tray 51, and the pulling-in device 80 may be disposed on the apparatus main body 1a side, such as an end portion on a back surface side of the apparatus main body 1a. However, in a case where the pulling-in device 80 is disposed in the paper feed tray 51, it is possible to omit an installation space on the back surface side of the apparatus main body 1a compared to a case where the pulling-in device 80 is disposed on the back surface side of the apparatus main body 1a, and it is possible to reduce the size of the apparatus main body 1a.

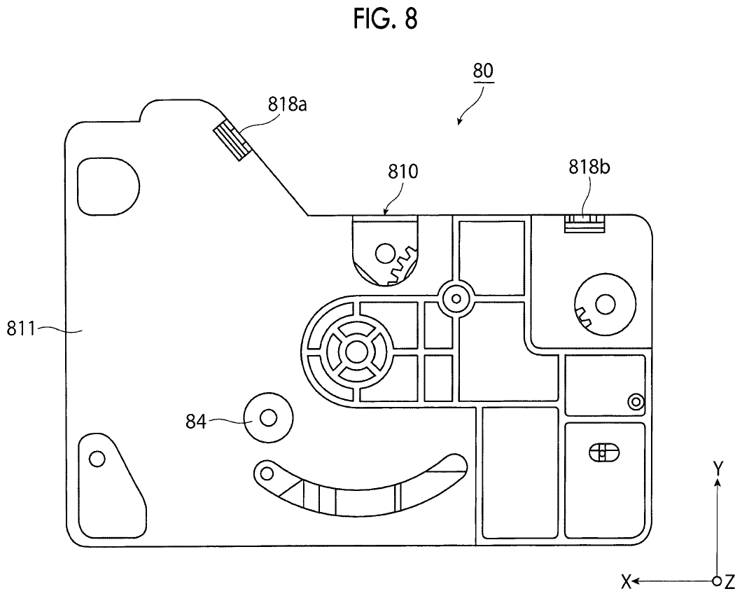

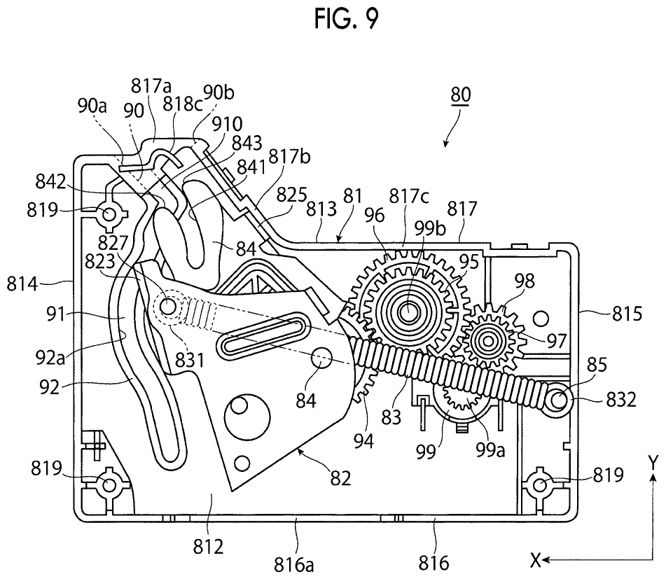

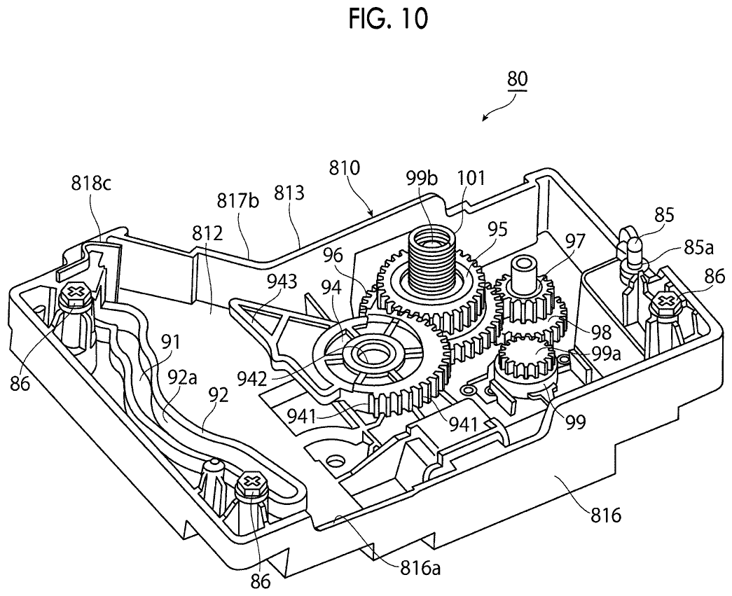

As shown in FIG. 8, the pulling-in device 80 is configured to have a flat box shape that is relatively low in height and that has a substantially rectangular shape in a plan view, of which one end portion (upper end portion in the figure) protrudes in a trapezoidal shape toward the rear side in the depth direction Y. As shown in FIGS. 9 and 10, the pulling-in device 80 includes, broadly speaking, an accommodation case 81, a bracket 82, a coil spring 83, a plurality of gears 94 to 98, a low-torque damper 99, and the like.

As shown in FIG. 8, the accommodation case 81 is constituted by a case main body 810 and a lid body 811 that closes an upper end surface of the case main body 810. As shown in FIG. 9, the case main body 810 includes a bottom wall 812 and an outer peripheral wall 813 that covers an entire outer periphery of the bottom wall 812. The bottom wall 812 of the case main body 810 partially has different heights, that is, different positions along the vertical direction Z of the bottom wall 812. The bottom wall 812 is set such that a region where a guide groove 91, which will be described later, is provided is relatively high, and a region where the plurality of gears 94 to 98 and the low-torque damper 99 are provided is relatively low.

The outer peripheral wall 813 of the case main body 810 has left and right side walls 814 and 815 located on the left and right along the horizontal direction X and front and rear side walls 816 and 817 located on the front and rear along the depth direction Y. As shown in FIG. 9, the rear side wall 817 of the case main body 810 is constituted by a first rear side wall 817a, an inclined wall 817b, and a second rear side wall 817c. The first rear side wall 817a is located at an end portion closest to the rear side along the depth direction Y and is formed to be short along the horizontal direction X. The inclined wall 817b is provided to be inclined from an end portion of the first rear side wall 817a on the right side in the figure toward the front side along the depth direction Y. The second rear side wall 817c is located at an end portion closest to the front side along the depth direction Y and is formed to be relatively long along the horizontal direction X. An introduction port 90 for introducing the engaging pin 77 on the apparatus main body 1a side is provided in the first rear side wall 817a of the case main body 810. As shown in FIG. 9, the introduction port 90 is formed in a substantially V-shape having both side surfaces 90a and 90b that are inclined at about 45 degrees to the left and right with respect to the depth direction Y, which is a pulling-in direction. In addition, the front side wall 816 of the case main body 810 is provided with a cutout portion 816a that allows rotational movement of the bracket 82.

The case main body 810 is closed by the lid body 811 with which the upper end surface is snap-engaged as shown in FIG. 8 in a state in which the bracket 82, the coil spring 83, the plurality of gears 94 to 98, the low-torque damper 99, and the like are stored. In the figure, reference symbols 818a and 818b respectively denote snap engagement portions. In addition, reference symbol 818c denotes a fixing piece that is engaged with a recessed groove (not shown) provided on an inner surface of the lid body 811 to be positioned and fixed. As shown in FIG. 10, the case main body 810 is attached to the paper feed tray 51 by fastening screws 86 through attachment holes 819 (see FIG. 9) provided at three corners of the bottom wall 812.

As shown in FIGS. 9 and 10, the guide groove 91 is provided on the bottom wall 812 of the case main body 810 in a state of communicating with the introduction port 90 of the first rear side wall 817a. A standing wall 92 in which the bottom wall 812 of the case main body 810 is elevated toward an inside is formed on an entire outer periphery of the guide groove 91. An inner peripheral surface 92a of the standing wall 92 functions as a guide surface that guides the engaging pin 77.

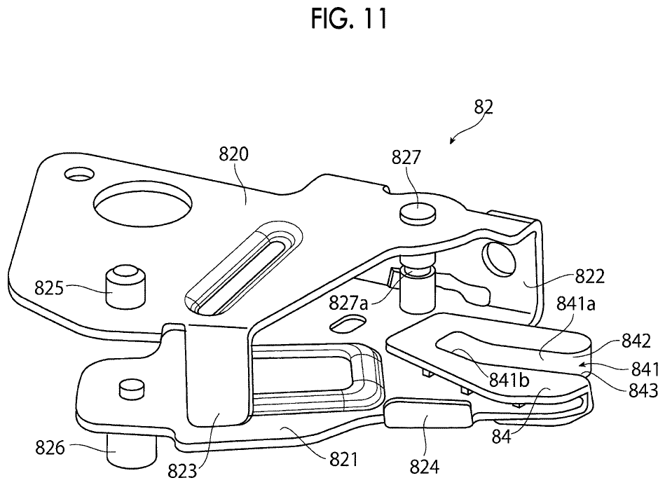

The bracket 82 that rotationally moves by being engaged with the engaging pin 77 is mounted inside the case main body 810 to be rotationally movable. As shown in FIG. 11, the bracket 82 is configured as a hollow frame having a substantially rectangular cross section by bending and processing a sheet metal. The bracket 82 has an upper end portion 820 and a lower end portion 821 that are disposed substantially parallel to each other. The upper end portion 820 and the lower end portion 821 of the bracket 82 are connected to each other by a side wall portion 822 located at an end portion on a guide groove 91 side. The bracket 82 is configured to have a hollow shape in which the upper end portion 820 and the lower end portion 821 are spaced apart from each other vertically, except for the side wall portion 822. In the bracket 82, a restriction plate 823 that restricts a position of the coil spring 83 is provided at an end portion of the bracket 82 on a side facing the side wall portion 822 in a state of being bent downward from an end portion of the upper end portion 820. In addition, a stopper piece 824 is provided at an end portion of the lower end portion 821 of the bracket 82 on an introduction port 90 side facing the side wall portion 822 in a state of being bent upward. The stopper piece 824 abuts on an inner surface of the inclined wall 817b of the case main body 810 to stop the rotational movement of the bracket 82 along a clockwise direction.

The bracket 82 is supported by rotational movement shafts 825 and 826 to be rotationally movable with respect to the case main body 810 and the lid body 811. The rotational movement shafts 825 and 826 are disposed to protrude from the upper end portion 820 and the lower end portion 821 of the bracket 82 in an up-down direction, respectively.

An engaging member 84 is integrally provided at the end portion of the lower end portion 821 of the bracket 82 on the introduction port 90 side. The engaging member 84 has an engaging groove 841 that engages with the engaging pin 77. The engaging member 84 consists of a synthetic resin or the like. The engaging member 84 is fitted to a tip end of the lower end portion 821 of the bracket 82 so as to sandwich the tip end between both front and rear surfaces, or is fixed to the bracket 82 by means such as adhesion. The engaging groove 841 has a straight portion 841a that is disposed in a straight line along one side surface 90a of the introduction port 90 and a bent portion 841b that is short and bent along the pulling-in direction at an end portion of the straight portion 841a on a deep side. Open ends 842 and 843 of the engaging groove 841 are formed in a curved shape such that the engaging pin 77 can be introduced. The engaging groove 841 may be directly formed in the sheet metal that constitutes the bracket 82.

As shown in FIG. 9, one end 831 of the coil spring 83 constituting a tension spring as an example of a biasing unit that applies a rotational moment to the bracket 82 is locked to the bracket 82. As shown in FIG. 11, one end 831 of the coil spring 83 is locked to a locking portion 827a formed with a small outer diameter in a locking pin 827 provided in the vicinity of the side wall portion 822 of the bracket 82. In addition, as shown in FIG. 10, the other end 832 of the coil spring 83 is locked to a locking portion 85a of a locking pin 85 which is fixed to a lower side of the right side wall 815 of the case main body 810. The coil spring 83 is always in an extended state, and exerts a tensile force corresponding to a spring constant of the coil spring 83 on the bracket 82.

In a state before the bracket 82 engages with the engaging pin 77, the bracket 82 is located at a stop position where the engaging groove 841 is rotated slightly clockwise from a position facing the introduction port 90 as shown in FIG. 9. In this case, the coil spring 83 is located on an upper side in the figure, which is slightly closer to the rear side of the paper feed tray 51 than the rotational movement shafts 825 and 826 of the bracket 82. As a result, a clockwise moment acts on the bracket 82 due to a contraction force of the coil spring 83. The bracket 82 is stopped by the stopper piece 824 abutting on the inner surface of the case main body 810.

As shown in FIG. 6, in the bracket 82, as the paper feed tray 51 is pushed into the inside of the apparatus main body 1a of the image forming apparatus 1, the engaging pin 77 on the apparatus main body 1a side moves from the introduction port 90 to an inside of the guide groove 91. Then, as shown in FIG. 9, the bracket 82 rotationally moves in a counterclockwise direction as the engaging pin 77 is engaged with the engaging groove 841 and the engaging pin 77 moves. In this case, the coil spring 83 moves to a lower side in FIG. 9, which is closer to the front side of the paper feed tray 51 than the rotational movement shafts 825 and 826 of the bracket 82. As a result, a counterclockwise moment acts on the bracket 82 due to the contraction force of the coil spring 83.

Then, the bracket 82 rotationally moves in a counterclockwise direction in a state in which a rotational moment caused by the contraction force of the coil spring 83 acts, as the engaging pin 77 moves inside the case main body 810 along the guide groove 91.

As shown in FIGS. 9 and 10, the plurality of gears 94 to 98 that transmit the rotation of the bracket 82 to the low-torque damper 99 are disposed inside the case main body 810. The first gear 94 is fixed to the bracket 82. The first gear 94 rotationally moves together with the bracket 82. The bracket 82 rotationally moves inside the case main body 810 by a required angle (approximately 180 degrees). The first gear 94 is provided with teeth 941 constituting the first gear 94 only in a region where the bracket 82 rotationally moves. Specifically, the teeth 941 are formed on the first gear 94 over an angle of approximately 180 degrees, which is an angle range in which the bracket 82 is rotationally movable.

As shown in FIG. 10, an insertion port 942 into which the rotational movement shaft 826 of the bracket 82 is inserted in a rotational movement-stopped state is provided at a center of the first gear 94. In addition, the first gear 94 is provided with a protruding portion 943 having a substantially triangular shape in a plan view, which extends radially outward at a position facing the region in which the teeth 941 are provided. The protruding portion 943 abuts on the inner surface of the inclined wall 817b of the case main body 810 in a case where the first gear 94 rotationally moves clockwise together with the bracket 82, thereby stopping the rotational movement of the bracket 82 together with the stopper piece 824.

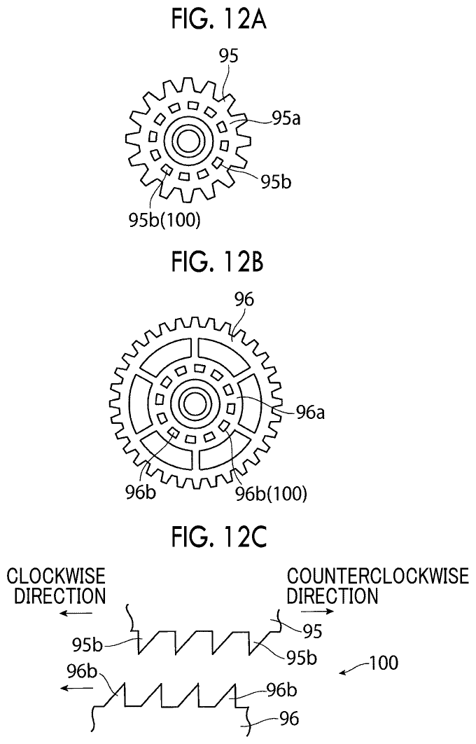

The first gear 94 meshes with the second gear 95 included in a plurality of speed-up gear trains. The number of teeth n2 of the second gear 95 is smaller than the number of teeth n1 of the first gear 94 in terms of the entire circumference. An outer diameter R1 of the first gear 94 is larger than an outer diameter R2 of the second gear 95. Reference symbols R1, R2, and the like indicating the outer diameters of the first gear 94 and the second gear 95 are not shown. Therefore, the rotation of the first gear 94 is transmitted to the second gear 95 at an increased speed according to a ratio between the numbers of teeth. The third gear 96 that is disposed to be coaxial with and rotatable about a rotation shaft 99b is disposed below the second gear 95. An outer diameter R3 of the third gear 96 is larger than the outer diameter R2 of the second gear 95. The number of teeth n3 of the third gear 96 is larger than the number of teeth n2 of the second gear 95. The second gear 95 and the third gear 96 constitute a mechanical one-way clutch 100. As shown in FIG. 12A, a plurality of protrusions 95b having a right-angled triangular cross section are provided on a lower surface 95a of the second gear 95 at equal intervals along a circumferential direction about the rotating shaft 99b. On the other hand, as shown in FIG. 12B, a plurality of protrusions 96b having a right-angled triangular cross section that meshes with the protrusion 95b of the second gear 95 are provided on an upper surface 96a of the third gear 96 at equal intervals along the circumferential direction about the rotating shaft 99b. The second gear 95 is brought into pressure contact with the third gear 96 by the coil spring 101. The coil spring 101 is pressed by the inner surface of the lid body 811 by mounting the lid body 811 on the case main body 810.

With reference to FIG. 12C, in the mechanical one-way clutch 100, in a case where the second gear 95 rotates clockwise, the protrusions 95b of the second gear 95 mesh with the protrusions 96b of the third gear 96 to transmit a rotational force to the third gear 96. On the other hand, in a case where the second gear 95 rotates counterclockwise, an inclined surface of the protrusion 95b of the second gear 95 rides on an inclined surface of the protrusion 96b of the third gear 96 and slips, and the rotation force of the second gear 95 is not transmitted to the third gear 96. Therefore, in a case where the bracket 82 rotates clockwise in a case where the paper feed tray 51 is pulled out from the apparatus main body 1a, the second gear 95 rotates counterclockwise, and the rotation of the bracket 82 is not transmitted to the third gear 96 by the mechanical one-way clutch 100.

Furthermore, the third gear 96 meshes with the fourth gear 97. An outer diameter R4 of the fourth gear 97 is smaller than the outer diameter R3 of the third gear 96. The number of teeth n4 of the fourth gear 97 is smaller than the number of teeth n3 of the third gear 96. A fifth gear 98 is provided coaxially and integrally with the fourth gear 97. An outer diameter R5 of the fifth gear 98 is larger than the outer diameter R4 of the fourth gear 97. The number of teeth n5 of the fifth gear 98 is larger than the number of teeth n4 of the fourth gear 97.

The fifth gear 98 meshes with a sixth gear 99a provided in the low-torque damper 99. An outer diameter R6 of the sixth gear 99a is smaller than the outer diameter R5 of the fifth gear 98. The number of teeth n6 of the sixth gear 99a is smaller than the number of teeth n5 of the fifth gear 98. The low-torque damper 99 is fixed to the bottom wall 812 formed one step lower than the case main body 810. In a case where a rotational force (torque) acts on the sixth gear 99a of the low-torque damper 99, the low-torque damper 99 limits the torque to a substantially constant torque having a relatively low value. A torque damper is, for example, a buffering device that limits the torque acting on a rotating shaft of the sixth gear 99a to a constant value by using viscosity resistance of oil. The value of the torque that can be limited by the low-torque damper 99 is set to be relatively low. The low-torque damper 99 is smaller and less expensive than a high-torque damper.

In the first exemplary embodiment, the rotation of the bracket 82 is transmitted to the low-torque damper 99 by a plurality of stages (three stages) of speed-up gear trains consisting of the plurality of gears 94 to 98. On the contrary, the limited torque of the low-torque damper 99 is amplified through the plurality of gears 94 to 98 and transmitted to the bracket 82. Therefore, in the case of the pulling-in device 80 according to the first exemplary embodiment, even in a case where the low-torque damper 99 that is small and inexpensive is used, it is possible to apply a sufficiently large limited torque to the bracket 82.

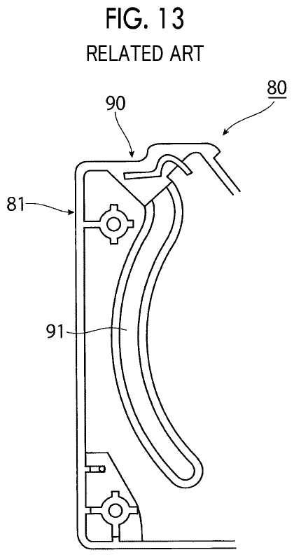

Incidentally, in the sheet accommodation device 50 in the related art, as shown in FIG. 13, a shape of the guide groove 91 of the pulling-in device 80 is formed in an arc shape having a substantially constant radius of curvature.

Therefore, in the sheet accommodation device 50 in the related art, in a case where the paper feed tray 51 is strongly pushed into the inside of the apparatus main body 1a by the user, the rotational moment acting on the bracket 82 via the engaging pin 77 of the apparatus main body 1a becomes excessive. Therefore, the low-torque damper 99 that limits the rotational movement of the bracket 82 to a substantially constant torque may not adequately function. As a result, there is a technical problem in that a pulling-in speed of the paper feed tray 51 is unintentionally increased and the paper feed tray 51 cannot be sufficiently decelerated.

On the other hand, in the sheet accommodation device 50 in the related art, the shape of the guide groove 91 is formed in an arc shape having a substantially constant radius of curvature. Therefore, a pulling-in force acting on the paper feed tray 51 is substantially constant. As a result, the pulling-in force acting on the paper feed tray 51 is insufficient in a state in which the paper feed tray 51 is pushed into the inside of the apparatus main body 1a, and the paper feed tray 51 may not be pulled in.

In particular, in the sheet accommodation device 50 in the related art, in order to reduce the cost, the low-torque damper 99 is used as a member constituting the pulling-in device 80, or a mechanical device is used as a substitute by removing a component such as the one-way clutch 100. In this case, in the sheet accommodation device 50 in the related art, due to variations in internal reaction force generated in a case where the paper feed tray 51 is mounted in the apparatus main body 1a, the following technical problems are incurred. That is, in the sheet accommodation device 50 in the related art, a portion where the pulling-in speed of the paper feed tray 51 is increased and a portion where the pulling-in force is insufficient are present due to the insufficient limited torque by the low-torque damper 99 or an operational delay caused by the omission of the one-way clutch 100.

Therefore, the sheet accommodation device according to the first exemplary embodiment is configured such that a resistance force applying portion that applies a resistance force for the pulling-in operation of the sheet accommodation body is provided in the guide groove of the pulling-in unit in order to adjust the pulling-in force of the sheet accommodation body.

In addition, in the sheet accommodation device according to the first exemplary embodiment, the resistance force applying portion is disposed on an end side of the guide groove on which the pulling-in operation for the sheet accommodation body starts.

Further, in the sheet accommodation device according to the first exemplary embodiment, the resistance force applying portion is formed of a region in which the guide groove is bent and/or curved with respect to the pulling-in direction of the sheet accommodation body. In addition, the resistance force applying portion is formed of a region having a plurality of bends with respect to the pulling-in direction of the sheet accommodation body.

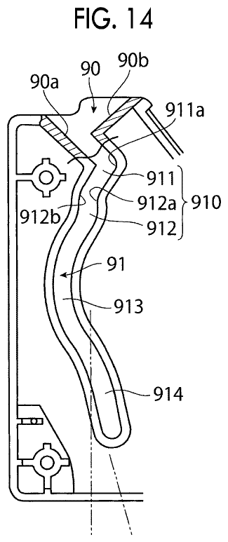

That is, as shown in FIGS. 10 and 14, the sheet accommodation device 50 according to the first exemplary embodiment includes, in the guide groove 91 provided in the accommodation case 81 of the pulling-in device 80, a resistance force applying portion 910 consisting of the region in which the guide groove 91 is bent and/or curved with respect to the pulling-in direction of the paper feed tray 51.

As shown in FIG. 14, the resistance force applying portion 910 is disposed at an end portion of the guide groove 91 on the introduction port 90 side, which is a start end for the pulling-in operation. The resistance force applying portion 910 is constituted by a bent portion 911 in which the guide groove 91 located at the end portion on the introduction port 90 side is bent at approximately 90 degrees and a curved portion 912 in which the guide groove 91 located at a tip end of the bent portion 911 is curved at an angle larger than 90 degrees. The bent portion 911 and the curved portion 912 are set such that bending and curving directions are opposite to each other. A start end portion of the guide groove 91 for the pulling-in operation is disposed in a straight shape along one side surface 90a of the introduction port 90. The bent portion 911 of the resistance force applying portion 910 is formed by being bent short by approximately 90 degrees from a short straight portion continuing from the start end portion of the guide groove 91 for the pulling-in operation.

The bent portion 911 of the resistance force applying portion 910 has an outer peripheral surface 911a formed in an arc shape. Therefore, the engaging pin 77 having a circular cross section smoothly comes into contact with the outer peripheral surface 911a of the bent portion 911. In addition, the curved portion 912 of the resistance force applying portion 910 has both inner and outer peripheral surfaces 912a and 912b formed in a curved shape.

The guide groove 91 has an intermediate portion 913 continuing from the resistance force applying portion 910 and being formed in an elongated arc shape having a constant radius of curvature. The intermediate portion 913 has a center O of the arc at a required distance along a direction intersecting the pulling-in direction. In a case where the engaging pin 77 moves in the intermediate portion 913 of the guide groove 91, the engaging pin 77 receives the pulling-in force along the pulling-in direction from the coil spring 83.

In addition, in the sheet accommodation device 50 according to the first exemplary embodiment, the guide groove 91 includes a promoting portion 914 that promotes the pulling-in operation for the paper feed tray 51. The promoting portion 914 is disposed on an end side of the guide groove 91 on which the pulling-in operation for the paper feed tray 51 ends. The promoting portion 914 is formed in a straight shape that is slightly inclined with respect to the depth direction Y, which is the pulling-in direction, from an end of the intermediate portion 913. Therefore, the engaging pin 77 that moves along the promoting portion 914 moves in a direction away from the rotational movement shafts 825 and 826 of the bracket 82, that is, the pulling-in force applied by the bracket 82 is increased, and the pulling-in operation is promoted.

### Action of Sheet Accommodation Device

In the sheet accommodation device according to the first exemplary embodiment, the pulling-in force of the sheet accommodation body can be adjusted as follows, compared to a case where the resistance force applying portion is not provided in the guide groove of the pulling-in unit.

That is, as shown in FIG. 6, in the sheet accommodation device 50 according to the first exemplary embodiment, the paper feed tray 51 is pulled out to the front surface side of the apparatus main body 1a by the user in a case of replenishing the inside of the paper feed tray 51 with the recording paper 5 or the like. Then, the inside of the paper feed tray 51 is replenished with the recording paper 5. Thereafter, the paper feed tray 51 is mounted at the paper feed position in the apparatus main body 1a by the user pushing the paper feed tray 51 into the inside of the apparatus main body 1a via the grip portion 517 of the operation panel 516.

In this case, in a case where the paper feed tray 51 is pushed into the inside of the apparatus main body 1a to some extent, the engaging pin 77 of the apparatus main body 1a is introduced to an inside from the introduction port 90 of the pulling-in device 80 provided in the paper feed tray 51. In this case, the engaging pin 77 is located at any position within a movable range of the swing arm 78 as shown in FIG. 7. As shown in FIG. 14, the introduction port 90 of the pulling-in device 80 is open in a substantially V-shape in a plan view. Therefore, the engaging pin 77 is introduced into the inside of the introduction port 90 along both side surfaces 90a and 90b that are open in a substantially V-shape of the introduction port 90 of the pulling-in device 80.

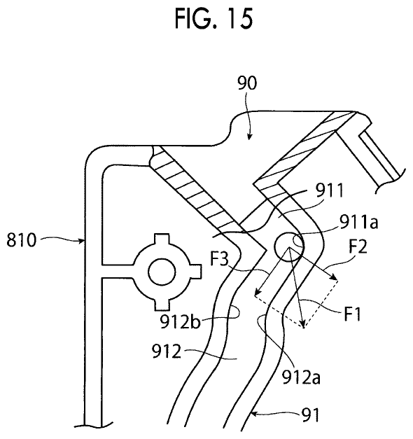

As the engaging pin 77 of the apparatus main body 1a is introduced into the pulling-in device 80, the paper feed tray 51 is connected to the apparatus main body 1a via the engaging pin 77 and the pulling-in device 80. As shown in FIG. 15, in a case where the engaging pin 77 is introduced into the inside of the pulling-in device 80 from the introduction port 90, the engaging pin 77 moves to the guide groove 91 provided continuous with the introduction port 90. The resistance force applying portion 910 is provided at the start end portion of the guide groove 91 for the pulling-in operation, that is, an entrance of the guide groove 91. Therefore, in a case where the engaging pin 77 moves from the introduction port 90 to the guide groove 91, the engaging pin 77 is subjected to a resistance force by the resistance force applying portion 910 provided at the start end portion of the guide groove 91 for the pulling-in operation.

As shown in FIG. 15, the resistance force applying portion 910 of the guide groove 91 includes the bent portion 911 that is bent at approximately 90 degrees with respect to an introduction direction from the introduction port 90 and the curved portion 912 that is curved at an angle larger than 90 degrees with respect to the bending direction of the bent portion 911. Therefore, the engaging pin 77 abuts on the outer peripheral surface 911a of the bent portion 911 included in the resistance force applying portion 910 of the guide groove 91, and a moving direction of the engaging pin 77 is changed by approximately 90 degrees. In this case, it is assumed that a pulling-in force F1 acts on the engaging pin 77 along the pulling-in direction.

In this case, the engaging pin 77 comes into contact with the outer peripheral surface 911a of the bent portion 911, and thus, the engaging pin 77 receives a resistance force −F2 that is substantially equal in magnitude and opposite in direction to a contact force F2, which is a force component of the pulling-in force F1 acting on the outer peripheral surface 911a. At the same time, the engaging pin 77 is subjected to a propulsion force F3, which is a reduced component of the pulling-in force F1 acting parallel to the outer peripheral surface 911a of the bent portion 911.

Similarly, the engaging pin 77 receives a resistance force from the inner and outer peripheral surfaces 912a and 912b of the curved portion 912 of the resistance force applying portion 910 in a case of passing through the curved portion 912, and the initial pulling-in force F1 is greatly reduced.

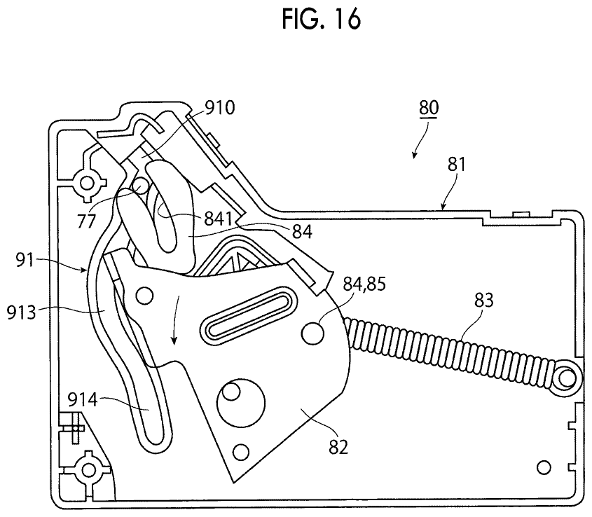

In addition, in the pulling-in device 80 according to the first exemplary embodiment, as shown in FIG. 16, in a case where the engaging pin 77 moves through the resistance force applying portion 910 of the guide groove 91, the bracket 82 engaged with the engaging pin 77 rotationally moves counterclockwise. Then, the rotation of the bracket 82 is transmitted to the low-torque damper 99 via the first to fifth gears 94 to 98. Therefore, in the rotation of the bracket 82, the limited torque by the low-torque damper 99 acts to be amplified through the first to fifth gears 94 to 98.

As a result, in a case where the engaging pin 77 moves through the resistance force applying portion 910, the limited torque by the low-torque damper 99 amplified by the first to fifth gears 94 to 98 acts in addition to the resistance force by the resistance force applying portion 910. Therefore, even in a case where the paper feed tray 51 is forcefully pushed into the inside of the apparatus main body 1a by the user, the pulling-in force of the engaging pin 77 is greatly reduced by the resistance force applying portion 910, the rotational torque of the bracket 82 is limited, and a pushing-in operation of the paper feed tray 51 is braked.

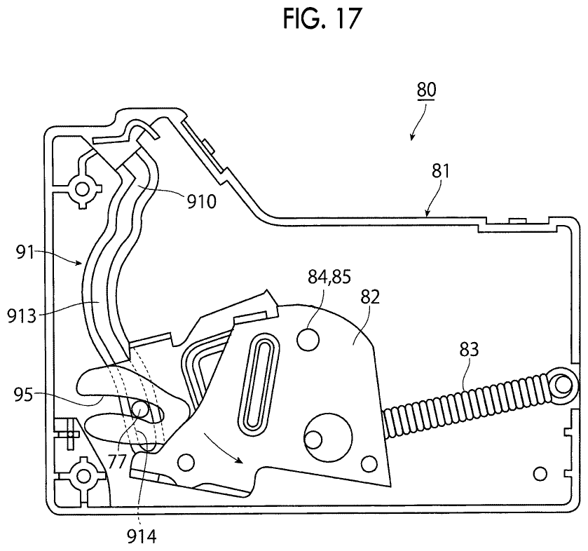

Thereafter, as shown in FIG. 17, the engaging pin 77 moves to the promoting portion 914 via the intermediate portion 913 of the guide groove 91. The promoting portion 914 of the guide groove 91 is provided in a straight shape and in a direction away from the rotational movement shafts 825 and 826 of the bracket 82. Therefore, a sufficient rotational moment in the counterclockwise direction is applied to the engaging pin 77 passing through the promoting portion 914 of the guide groove 91 by the coil spring 83 that is slightly extended. Accordingly, the engaging pin 77 can be reliably pulled in toward the end of the promoting portion 914 of the guide groove 91.

Therefore, with the sheet accommodation device 50 according to the first exemplary embodiment, even in a case where the paper feed tray 51 is forcefully pushed into the inside of the apparatus main body 1a, a sufficient braking force can be applied to the paper feed tray 51, compared to a case where the guide groove 91 of the pulling-in device 80 is not provided with the resistance force applying portion 910.

In addition, with the sheet accommodation device 50 according to the first exemplary embodiment, the paper feed tray 51 can be reliably pulled into the inside of the apparatus main body 1a without insufficiency of the pulling-in force acting on the paper feed tray 51, compared to a case where the guide groove 91 of the pulling-in device 80 is not provided with the promoting portion 914.

### COMPARATIVE EXAMPLE

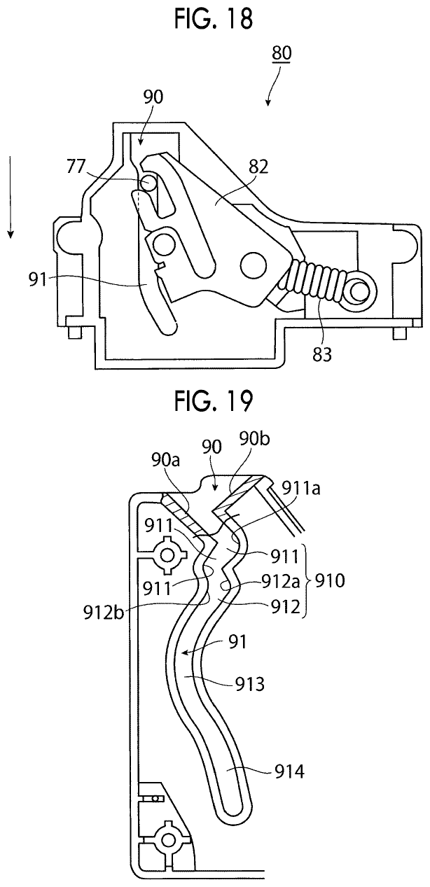

FIG. 18 is a configuration diagram showing a comparative example.

In this comparative example, the end portion of the guide groove 91 on the introduction port side is formed in a straight shape along the pulling-in direction. Therefore, in a case where the paper feed tray 51 is pushed in forcefully, there is a technical problem in that the paper feed tray 51 cannot be decelerated and the low-torque damper does not work.

### Second Exemplary Embodiment

FIG. 19 is a configuration diagram showing a sheet accommodation device according to a second exemplary embodiment.

The sheet accommodation device according to the second exemplary embodiment is different from the first exemplary embodiment in the shape of the guide groove.

That is, in the sheet accommodation device 50 according to the second exemplary embodiment, as shown in FIG. 19, the resistance force applying portion 910 of the guide groove 91 is configured to consist of bent portions 911a and 911b having a plurality of (two in the illustrated example) bends with respect to the pulling-in direction of the paper feed tray 51 and one curved portion 912 that is curved.

As described above, in the sheet accommodation device 50 according to the second exemplary embodiment, by configuring the resistance force applying portion 910 of the guide groove 91 to consist of a plurality of bent portions 911c and 911d and one curved portion 912 that is curved, the resistance force acting on the engaging pin 77 can be further increased and the pulling-in speed of the paper feed tray 51 can be sufficiently reduced.

Since other configurations and actions are similar to the configurations and actions in the first exemplary embodiment, the description thereof will be omitted.

In the above exemplary embodiment, the case where an image is formed by an electrophotographic method as the image forming apparatus has been described, but the present invention is not limited thereto, and an image may be formed by another method such as an inkjet method.

In addition, in the above exemplary embodiment, the case where the sheet accommodation device is applied to the image forming apparatus has been described, but the present invention is not limited thereto, and it is needless to say that the sheet accommodation device may be applied to another device such as a paper feed device exclusively for paper feeding.

In addition, in the above exemplary embodiment, the case where the engaging pin is provided in the apparatus main body and the pulling-in device is disposed in the paper feed tray has been described, but the present invention is not limited thereto, and a configuration may be adopted in which the engaging pin is provided in the paper feed tray and the pulling-in device is disposed in the apparatus main body.

### SUPPLEMENTARY NOTES

(((1)))

A sheet accommodation device comprising:
a sheet accommodation body that accommodates a sheet and is mounted in an apparatus main body to be pullable out from and pullable into the apparatus main body;
an engaging unit that is provided on any one of the apparatus main body or the sheet accommodation body; and
a pulling-in unit that is provided on the other of the apparatus main body or the sheet accommodation body and that has a guide groove guiding a pulling-in operation of the sheet accommodation body by being engaged with the engaging unit, the guide groove being provided with a resistance force applying portion that applies a resistance force to the pulling-in operation of the sheet accommodation body.
   (((2)))

The sheet accommodation device according to (((1))),
wherein the resistance force applying portion is disposed on an end side of the guide groove on which the pulling-in operation for the sheet accommodation body starts.
   (((3)))

The sheet accommodation device according to (((2))),
wherein the resistance force applying portion is formed of a region in which the guide groove is bent and/or curved with respect to a pulling-in direction of the sheet accommodation body.
   (((4)))

The sheet accommodation device according to (((3))),
wherein the resistance force applying portion is formed of a region having a plurality of bends with respect to the pulling-in direction of the sheet accommodation body.
   (((5)))

The sheet accommodation device according to (((1))),
wherein the guide groove is provided with a promoting portion that promotes the pulling-in operation of the sheet accommodation body.
   (((6)))

The sheet accommodation device according to (((5))),
wherein the promoting portion is disposed on an end side of the guide groove on which the pulling-in operation for the sheet accommodation body ends.
   (((7)))

The sheet accommodation device according to (((6))),
wherein the promoting portion is formed of a region in which the guide groove is formed in a straight shape.
   (((8)))

The sheet accommodation device according to (((5))),
wherein the guide groove has, between the resistance force applying portion and the promoting portion, a curved portion that is curved in a direction intersecting a pulling-in direction of the sheet accommodation body.
   (((9)))

The sheet accommodation device according to (((8))),
wherein the curved portion is formed in an arc shape having a constant radius of curvature.
   (((10)))

An image forming apparatus comprising:
a sheet accommodation unit that accommodates a sheet; and
an image forming unit that forms an image on the sheet,
wherein the image forming apparatus uses the sheet accommodation device according to any one of (((1))) to (((9))) as the sheet accommodation unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A sheet accommodation device comprising:
a sheet accommodation body that accommodates a sheet and is mounted in an apparatus main body to be pullable out from and pullable into the apparatus main body;
an engaging unit that is provided on any one of the apparatus main body or the sheet accommodation body; and
a pulling-in unit that is provided on the other of the apparatus main body or the sheet accommodation body and that has a guide groove guiding a pulling-in operation of the sheet accommodation body by being engaged with the engaging unit, the guide groove being provided with a resistance force applying portion that applies a resistance force to the pulling-in operation of the sheet accommodation body.

2. The sheet accommodation device according to claim 1,
wherein the resistance force applying portion is disposed on an end side of the guide groove on which the pulling-in operation for the sheet accommodation body starts.

3. The sheet accommodation device according to claim 2,
wherein the resistance force applying portion is formed of a region in which the guide groove is bent and/or curved with respect to a pulling-in direction of the sheet accommodation body.

4. The sheet accommodation device according to claim 3,
wherein the resistance force applying portion is formed of a region having a plurality of bends with respect to the pulling-in direction of the sheet accommodation body.

5. The sheet accommodation device according to claim 1,
wherein the guide groove is provided with a promoting portion that promotes the pulling-in operation of the sheet accommodation body.

6. The sheet accommodation device according to claim 5,
wherein the promoting portion is disposed on an end side of the guide groove on which the pulling-in operation for the sheet accommodation body ends.

7. The sheet accommodation device according to claim 6,
wherein the promoting portion is formed of a region in which the guide groove is formed in a straight shape.

8. The sheet accommodation device according to claim 5,
wherein the guide groove has, between the resistance force applying portion and the promoting portion, a curved portion that is curved in a direction intersecting a pulling-in direction of the sheet accommodation body.

9. The sheet accommodation device according to claim 8,
wherein the curved portion is formed in an arc shape having a constant radius of curvature.

10. An image forming apparatus comprising:
a sheet accommodation unit that accommodates a sheet; and
an image forming unit that forms an image on the sheet,
wherein the image forming apparatus uses the sheet accommodation device according to claim 1 as the sheet accommodation unit.

11. An image forming apparatus comprising:
a sheet accommodation unit that accommodates a sheet; and
an image forming unit that forms an image on the sheet,
wherein the image forming apparatus uses the sheet accommodation device according to claim 2 as the sheet accommodation unit.

12. An image forming apparatus comprising:
a sheet accommodation unit that accommodates a sheet; and
an image forming unit that forms an image on the sheet,
wherein the image forming apparatus uses the sheet accommodation device according to claim 3 as the sheet accommodation unit.

13. An image forming apparatus comprising:
a sheet accommodation unit that accommodates a sheet; and
an image forming unit that forms an image on the sheet,
wherein the image forming apparatus uses the sheet accommodation device according to claim 4 as the sheet accommodation unit.

14. An image forming apparatus comprising:
a sheet accommodation unit that accommodates a sheet; and
an image forming unit that forms an image on the sheet,
wherein the image forming apparatus uses the sheet accommodation device according to claim 5 as the sheet accommodation unit.

15. An image forming apparatus comprising:
a sheet accommodation unit that accommodates a sheet; and
an image forming unit that forms an image on the sheet,
wherein the image forming apparatus uses the sheet accommodation device according to claim 6 as the sheet accommodation unit.

16. An image forming apparatus comprising:
a sheet accommodation unit that accommodates a sheet; and
an image forming unit that forms an image on the sheet,
wherein the image forming apparatus uses the sheet accommodation device according to claim 7 as the sheet accommodation unit.

17. An image forming apparatus comprising:
a sheet accommodation unit that accommodates a sheet; and
an image forming unit that forms an image on the sheet,
wherein the image forming apparatus uses the sheet accommodation device according to claim 8 as the sheet accommodation unit.

18. An image forming apparatus comprising:
a sheet accommodation unit that accommodates a sheet; and
an image forming unit that forms an image on the sheet,
wherein the image forming apparatus uses the sheet accommodation device according to claim 9 as the sheet accommodation unit.

19. A sheet accommodation device comprising:
a sheet accommodation body that accommodates a sheet and is mounted in an apparatus main body to be pullable out from and pullable into the apparatus main body;
an engaging unit that is provided on any one of the apparatus main body or the sheet accommodation body; and
a pulling-in unit that is provided on the other of the apparatus main body or the sheet accommodation body and that has a guide groove guiding a pulling-in operation of the sheet accommodation body by being engaged with the engaging unit, the guide groove being provided with a resistance force applying portion that applies a resistance force to the pulling-in operation of the sheet accommodation body.
